(19) United States
(12) Patent Application Publication
(10) Pub. No.: US 2014/0141646 A1
(43) Pub. Date: May 22, 2014

(54) COAXIAL CABLE CONNECTOR

(71) Applicant: Yueh Chiung LU, Tao Yuan Hsien (TW)

(72) Inventor: Yueh Chiung LU, Tao Yuan Hsien (TW)

(21) Appl. No.: 13/678,730

(22) Filed: Nov. 16, 2012

(51) Int. Cl. H01R 24/38

(52) U.S. Cl. CPC H01R 24/38
USPC 439/583

(57) ABSTRACT

A coaxial cable connector for connecting a coaxial cable to a mating device is disclosed to include a connector body including a body shell having a front neck and an inner tube mounted in the body shell and defining a shoulder, a locknut defining an inside constraint hole fitting the shoulder of the inner tube, and a contact spring member set in the inside constraint hole around the shoulder. The locknut has a thick part, and a thin part disposed at a front side of the thick part and inwardly curved to provide a plurality of contact points at a thread peak of an inner thread being extending around the inside wall of the thin part and thick part of the locknut for enabling the connected coaxial cable to be positively grounded upon installation in a mating device.

### BACKGROUND OF THE INVENTION

1. Field of the Invention

The present invention relates to coaxial cable connectors and more particularly, to a coaxial cable for connecting a coaxial cable to a mating device, for example, cable TV distributor or set-top box, which has a front part of the locknut made relatively thinner and inwardly curved to provide multiple contact points, ensuring positive grounding and enhancing signal transmission reliability.

2. Description of the Related Art

Different diameters of coaxial cables may be used for different applications. Conventional coaxial cable connectors are generally designed to fit one specific diameter of coaxial cable, U.S. application Ser. Nos. 13/274,308 and 13/412,972, invented by the present inventor, discloses similar coaxial cable connector designs suitable for assembly with one of a series of coaxial cables having one same specification and different wire outer diameters.

The aforesaid two prior art coaxial cable connector designs, the body shell of the connector body comprises a front neck, and an inside locating groove in the front neck for accommodating an O-ring; the locknut comprises an inside locating groove in a rear side thereof for accommodating an O-ring; a multi-contact spring member is mounted around the front neck of the body shell and kept in contact with the rear end edge of the locknut to keep an inside stop edge of the locknut in abutment with an annular stop edge of the inner tube of the connector body. When threading the locknut onto the F-connector of the mating device, the coaxial cable can be positively grounded for accurate signal transmission so that a high level of clearness of the displayed image at the terminal device is ensured.

However, the aforesaid multi-contact spring member is mounted around the front neck of the body shell and abutted against the rear end edge of the locknut to force the inside stop edge of the locknut against the annular stop edge of the inner tube of the connector body. The higher the abutment force between the locknut and the inner tube is, the better the coaxial cable grounding effect will be. Higher, when threading the locknut onto the F-connector of the mating device, much resistance will be produced, increasing installation difficulty. An improvement in this regard is desired.

According to the prior art design shown in FIG. 1, the coaxial cable connector 91 must be fastened to the coaxial cable 90 and then installed with the coaxial cable 90 in the mating device 92 (see FIG. 2). The connection interface between the coaxial cable connector 91 and the mating device 92 includes the locknut 93 of the coaxial cable connector 91 and the F-connector 95 of the mating device 92. The locknut 93 defines therein an inner thread 94 for threading onto an outer thread 96 of the F-connector 95.

During installation, the center conductor 97 of the coaxial cable 90 is inserted into the clamping contact 98 in the F-connector 95. After installation, the annular front end edge 902 of the inner tube 99 of the coaxial cable connector 91 must be kept in contact with the end edge 903 of the F-connector 95 so that the braided outer conductor 901 can be well grounded, ensuring a high level of signal transmission reliability.

However, the annular front end edge 902 of the inner tube 99 of the coaxial cable connector 91 may be not positively abutted against the end edge 903 of the F-connector 95 after the user fastened the locknut 93 to the outer thread 96 of the F-connector 95, or, after a long use, the locknut 93 may be loosened from the outer thread 96 of the F-connector 95, causing disconnection between the annular front end edge 902 of the inner tube 99 of the coaxial cable connector 91 and the end edge 903 of the F-connector 95. When this condition occurs, the coaxial cable 90 will not be well grounded, affecting signal transmission reliability.

Therefore, there is a strong demand for a coaxial cable connector that enables the coaxial cable to be positively grounded after installation in the mating device, assuring signal transmission stability and reliability between the coaxial cable and the mating device.

### SUMMARY OF THE INVENTION

The present invention has been accomplished under the circumstances in view. It is main object of the present invention to provide a coaxial cable connector for connecting a coaxial cable to a mating device, which enables the coaxial cable to be positively grounded after connection to the mating device.

To achieve this and other objects of the present invention, a coaxial cable connector comprises connector body and a locknut. The connector body comprises an inner tube and a body shell. The locknut is attached onto one end of the inner tube and fastened to the body shell. Further, the locknut comprises a thick part and a thin part at a front side of the thick part. The thin part is inwardly curved to provide a plurality of contact points at a thread peak of an inner thread that extends around the inside wall of the thin part and thick part of the locknut. Further, the diameter of the inner circle defined by the contact points is smaller than the diameter of the inner circle defined by the thread peak of the inner thread at the thick part.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a sectional assembly view of a coaxial cable connector according to the prior art.

FIG. 2 illustrates a conventional coaxial cable mating device,

FIG. 3 is an elevational view of a coaxial cable connector in accordance with the present invention.

FIG. 4 is an exploded view of the coaxial cable connector in accordance with the present invention.

FIG. 5 is a longitudinal sectional view of the coaxial cable connector in accordance with the present invention.

FIG. 6 is a front view of the coaxial cable connector in accordance with the present invention.

FIG. 7 is a front view of an alternate form of the coaxial cable connector in accordance with the present invention.

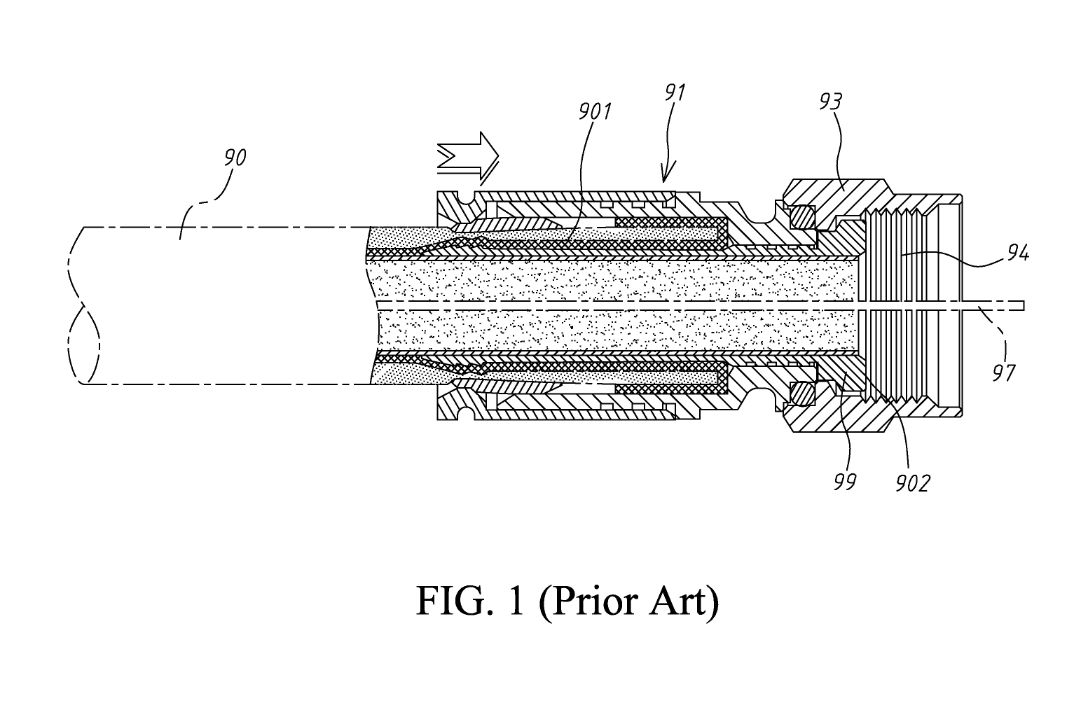

### DETAILED DESCRIPTION OF THE PREFERRED EMBODIMENT

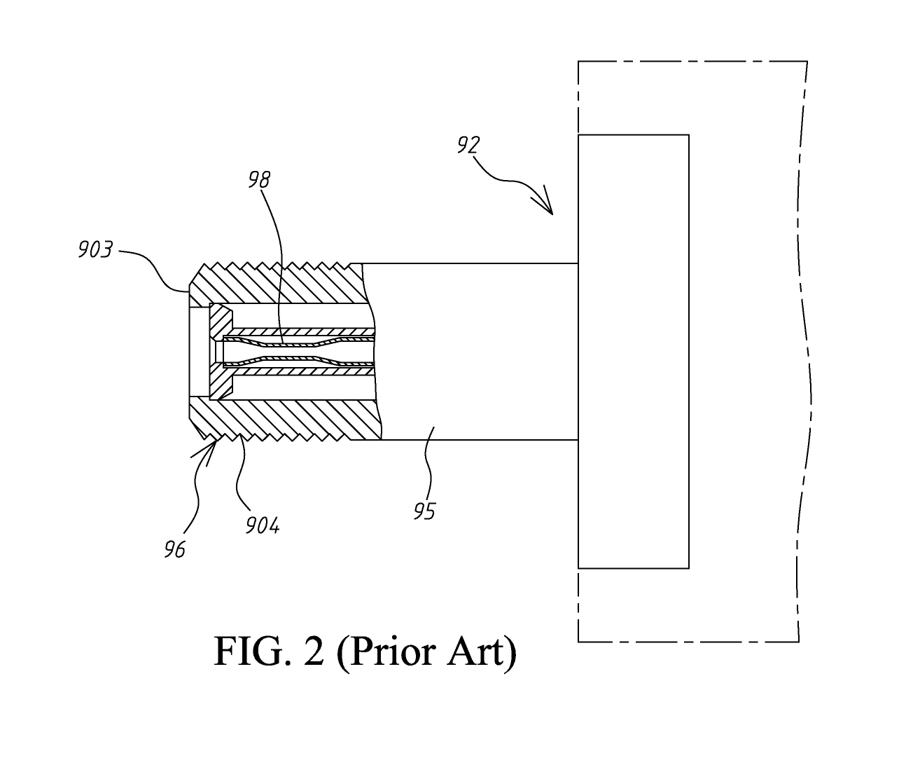

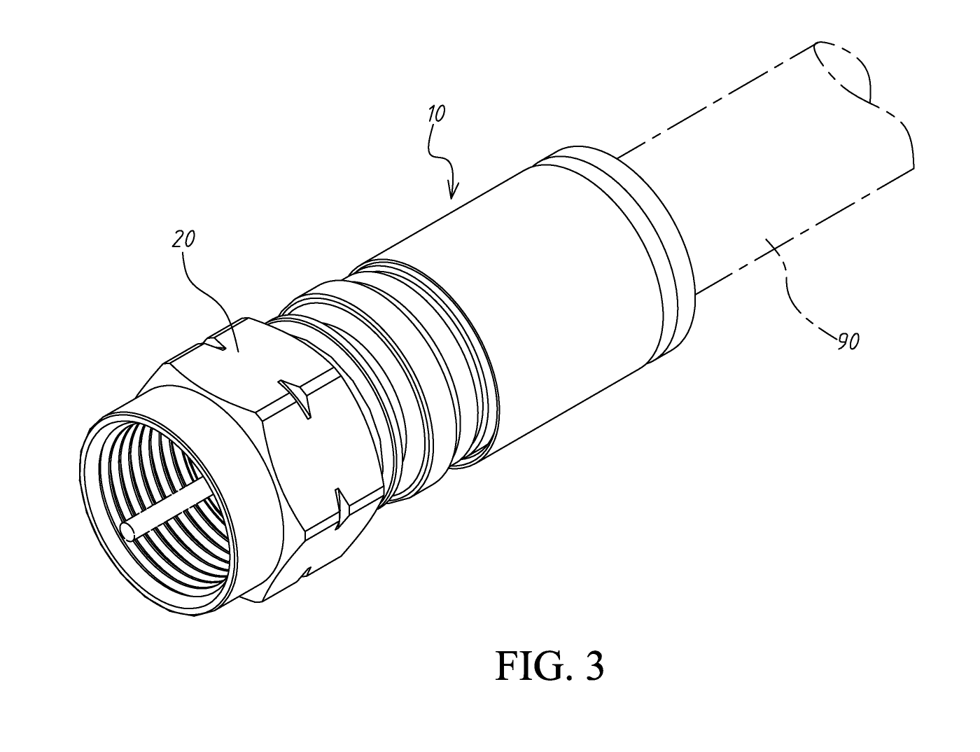

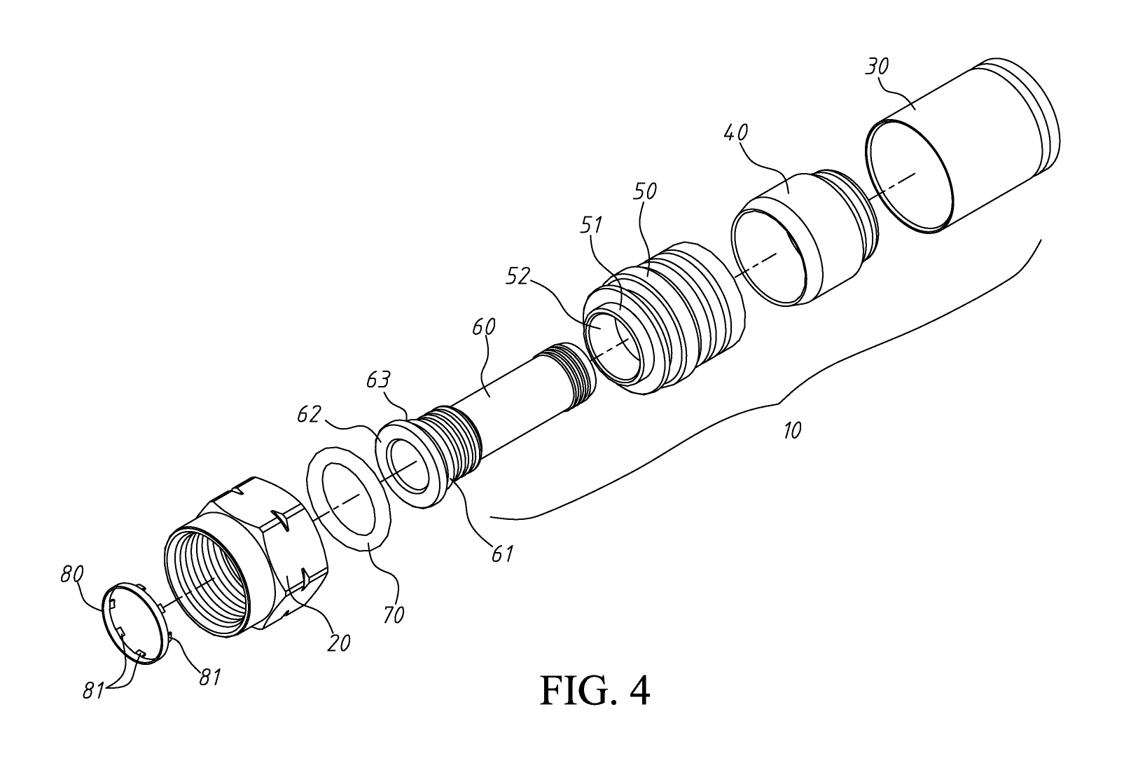

Referring to FIGS. 3 and 4, a coaxial cable connector in accordance with the present invention is shown comprising a connector body 10 and a locknut 20 and adapted for connecting a coaxial cable 90 to a mating device 92 (see also FIG. 2).

The connector body 10 comprises barrel 30, a plastic bushing 40 mounted in the barrel 30, a body shell 50 inserted into one end of the barrel 30 and attached to one end of the plastic bushing 40, and an inner tube 60 mounted in the body shell 50 and suspending in the plastic bushing 40 within the barrel 30. The body shell 50 comprises a front neck 51 defining therein a compression hole 52. The inner tube 60 is mounted in one end of the locknut 20, comprising an annular front end edge 62 radially disposed a front end thereof, an annular stop edge 63 radially extending around the periphery and disposed adjacent and opposite to the annular front end edge 62, and a shoulder 61 extending around the periphery and disposed adjacent to the annular stop edge 63. The inner tube 60 is inserted through the compression hole 52 into the inside of the body shell 50 and the inside of the plastic bushing 40 to abut the shoulder 61 against the front neck 51 of the body shell 50. The locknut 20 is attached onto one end of the inner tube 60 and a part of the periphery of the inner tube 60, comprising an inside locating groove 21 corresponding to the front neck 51 of the body shell 50, an inside constraint hole 22 corresponding to the shoulder 61 of the inner tube 60, an inside stop edge 23 located at an inner side of the inside constraint hole 22. Further, an O-ring 70 is set between the front neck 51 and the inside locating groove 21. Further, a contact spring member 80 is set between the shoulder 61 and the inside constraint hole 22.

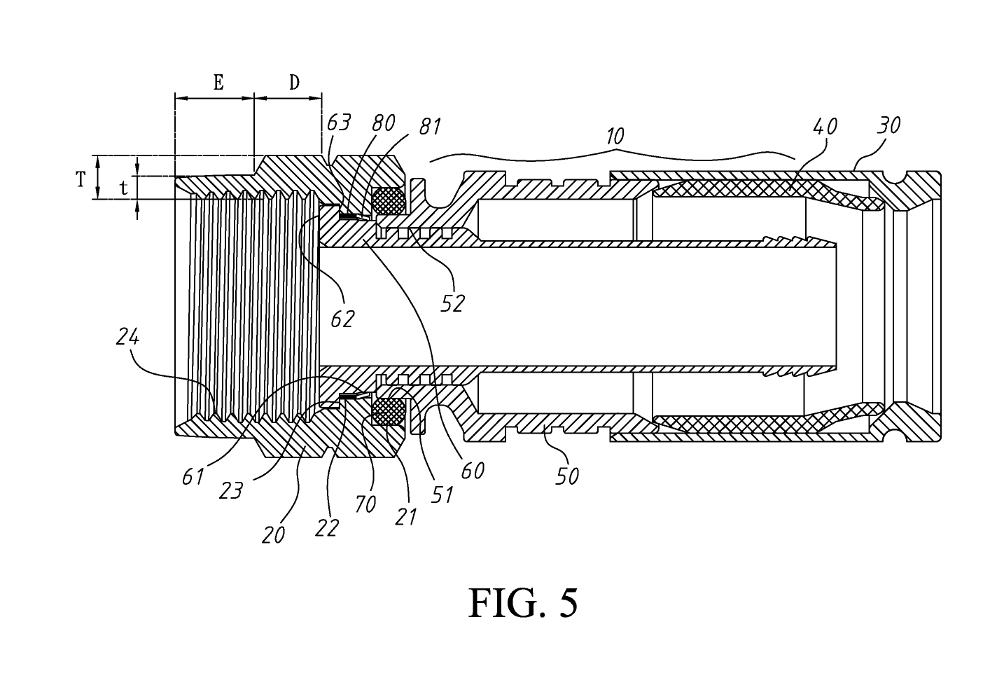

Referring to FIG. 5, the contact spring member 80 is a ring spring mounted in the inside constraint hole 22 of the locknut 20, comprising a plurality of contact strips 81 extended from the ring-shaped body thereof at predetermined intervals and at a predetermined angle toward the central axis of the coaxial cable connector, i.e., toward the center conductor 97 of the coaxial cable 90. The contact spring member 80 is configured subject to the diameter of the inside constraint hole 22 of the locknut 20. Thus, the contact spring member 80 can be press-fitted into the inside constraint hole 22 of the locknut 20 and positioned between the inside constraint hole 22 of the locknut 20 and the shoulder 61 of the inner tube 60 to stop the contact strips 81 against the shoulder 61 of the inner tube 60.

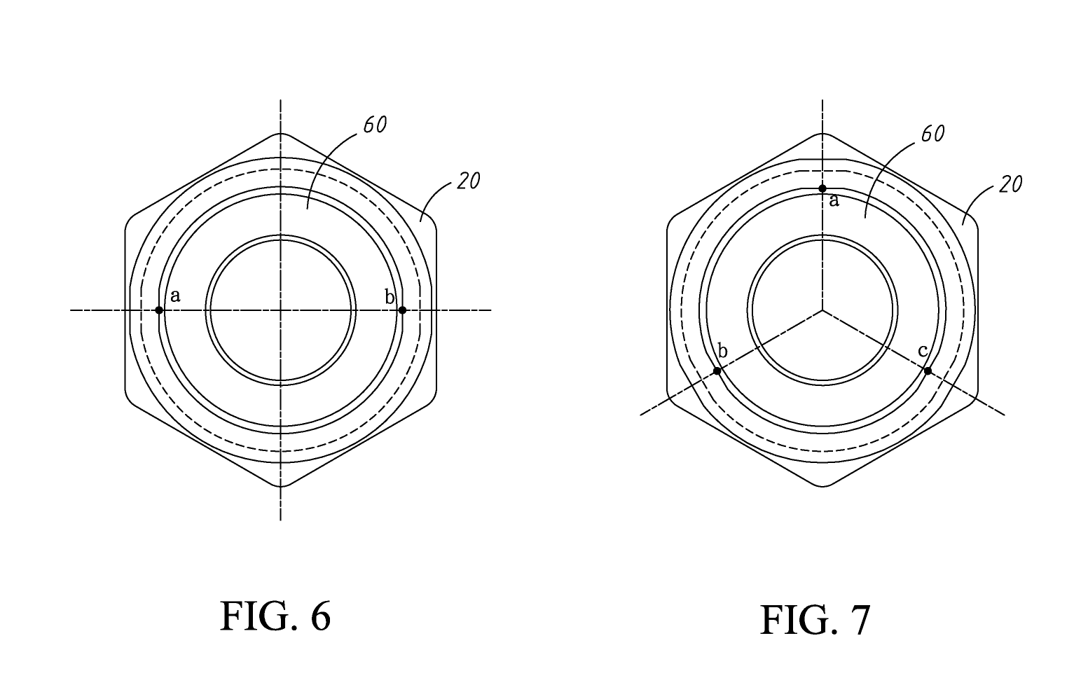

Further, as shown in FIG. 5, the locknut 20 has a thick part D and a thin part E arranged together at the front side. The thick part D has a thick thickness T. The thin part E has a thin thickness t. An external tool is used to deform the thin part E, curving the thin part E slightly inward to the extent that the thread peak 24 of the inner thread of the locknut 20 at the thin part E provides plurality of contact points. In the example shown in FIG. 6, the thread peak 24 of the inner thread of the locknut 20 at the thin part E provides two contact points a and b. In the example shown in FIG. 7, the thin part E provides three contact points a, b and c. In the example shown in FIG. 6, the two contact points a and b are disposed in a symmetric manner, and the diameter of the inner circle defined by the two contact points a and b is smaller than the diameter of the inner circle defined by the thread peak 24 of the inner thread at the thick part D. Thus, if the thread peak 24 of the inner thread of the locknut 20 is tightly engaged into the thread groove 904 of the mating device 92 when threading the locknut 20 onto the outer thread 96 of the mating device 92, the thin thickness t of the thin part E can be expanded easily, enabling the locknut 20 to be positively fastened to the outer thread 96 of the mating device 92. Even if the locknut 20 and the mating device 92 are not fastened tight, the contact points a and b can be kept in contact with the periphery of the mating device 92 to have the coaxial cable 90 be positively grounded.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A coaxial cable connector comprising a connector body and a locknut for connecting a coaxial cable to a mating device, said connector body comprising an inner tube and a body shell, said locknut being attached onto one end of said inner tube and fastened to said body shell, wherein said locknut comprises a thick part and a thin part at a front side of said thick part, said thin part being inwardly curved to provide a plurality of contact points at a thread peak of an inner thread being extending around an inside wall of said thin part and said thick part of said locknut, the diameter of the inner circle defined by said contact points being smaller than the diameter of the inner circle defined by the thread peak of the inner thread at said thick part.

2. The coaxial cable connector as claimed in claim 1, wherein said two inner contact points are disposed in a symmetric manner.

3. The coaxial cable connector as claimed in claim 1, wherein said connector body further comprises a barrel attached onto one end of said body shell remote from said locknut, and a plastic bushing mounted in said barrel and abutted against one end of said body shell opposite to said locknut, said body shell comprising a front neck, said inner tube being inserted through said front neck of said body shell into the inside of said body shell and the inside of said plastic bushing, said inner tube comprising a shoulder abutted against said front neck of said body shell; said locknut comprises an inside locating groove for receiving said front neck of said body shell and an inside constraint hole for receiving said shoulder of said inner tube.

4. The coaxial cable connector as claimed in claim 3, further comprising a contact spring member set between said shoulder of said inner tube and said inside constraint hole of said locknut.

5. The coaxial cable connector as claimed in claim 4, wherein said contact spring member comprises a ring-shaped body press-fitted into said inside constraint hole, and a plurality of contact trips extended from said ring-shaped body at an angle and spaced at predetermined intervals and stopped against said shoulder of said inner tube.

6. The coaxial cable connector as claimed in claim 3, further comprising an O-ring set between said front neck of said body shell and said inside locating groove of said locknut.
